(19) United States
(12) Patent Application Publication
(10) Pub. No.: US 2026/0336963 A1
(43) Pub. Date: Oct. 29, 2026

(54) MEDIUM PROCESSING APPARATUS, IMAGE FORMING APPARATUS, AND IMAGE FORMING SYSTEM

(71) Applicants: Keita SAKAKIBARA, Yokohama, Kanagawa (JP); Yuta YANAI, Yokohama, Kanagawa (JP); Yuji MIYACHI, Yokohama, Kanagawa (JP)

(72) Inventors: Keita SAKAKIBARA, Kanagawa (JP); Yuta YANAI, Kanagawa (JP); Yuji MIYACHI, Kanagawa (JP)

(73) Assignee: Ricoh Company, Ltd., Ohta-ku, Tokyo (JP)

(21) Appl. No.: 19/102,640

(22) PCT Filed: Oct. 23, 2023
(86) PCT No.: PCT/IB2023/060656

§ 371 Date: Feb. 10, 2025

(30) Foreign Application Priority Data
Oct. 31, 2022 (JP) 2022-174746

(51) Int. Cl. B65H 37/04; B31F 5/02; B42B 5/00; B42C 1/12

(52) U.S. Cl. CPC B65H 37/04; B31F 5/02; B42B 5/00; B42C 1/12; B65H 2301/51616; B65H 2403/51; B65H 2601/255; B65H 2801/27

(57) ABSTRACT

A medium processing apparatus includes a conveyor; a stacker; and a crimper to press and deform media stacked on the stacker to bind the media. The crimper includes: first binding teeth and second binding teeth, the second binding teeth movable between a pinching position to pinch the media with the first binding teeth and a retracted position retracted from the pinching position; a peeler to move to a separation position separated from the media toward the first binding teeth and a peeling position to peel the media from the first binding teeth; and a driving force transmission mechanism to move the second binding teeth between the pinching position and the retracted position by driving force of a single driving source, and to move the peeler from the separation position to the peeling position in conjunction with movement of the second binding teeth from the pinching position to the retracted position.

### TECHNICAL FIELD

Embodiments of the present disclosure relate to a medium processing apparatus, an image forming apparatus, and an image forming system.

### BACKGROUND ART

Medium processing apparatuses are known in the related art that bind sheet-shaped media, on which images are formed by image forming apparatuses, into a bundle of media. Since sheets of paper are widely known as an example of the sheet-shaped media, a “sheet bundle” that is a bundle or stack of sheets of paper is used as an example of a bundle of sheet-shaped media in the following description. From the viewpoint of saving resources and reducing environmental load, some medium processing apparatuses include a crimping unit that can perform so-called “crimping” to pinch a sheet bundle by a pair of concave-convex binding teeth and press and deform the sheet bundle without using metal staples.

The crimping is a method in which a bundle of sheets is pinched by a pair of binding teeth to entangled fibers of the sheets to bind the sheets. Accordingly, the fibers of the sheets may adhere to the binding teeth and hamper the binding teeth from separating from the sheet bundle. In order to solve such a problem, some medium processing apparatuses have been proposed that include a separation unit that separates the sheet bundle from the binding teeth (for example, refer to Patent Literature (PTL) 1 and PTL 2).

### CITATION LIST

### Patent Literature

### PTL 1

Japanese Unexamined Patent Application Publication No. 2015-067407

### PTL 2

Japanese Unexamined Patent Application Publication No. 2020-147005

### SUMMARY OF INVENTION

### Problem to be solved

However, in the medium processing apparatus described in PTL 1, the separation unit is disposed within the movable range of a movable one of the pair of binding teeth. As a result, the gap between the pair of binding teeth into which the sheets enter is narrow and the sheets may be jammed. In the medium processing apparatus described in PTL 2, the driving source for causing the pair of binding teeth to contact and separate from each other and the driving source for driving the separation unit are independently provided. As a result, the size and weight of the apparatus increase.

The present disclosure is made to solve such problems, and an object of the present disclosure is to provide a technique of preventing media from being jammed and achieving downsizing and weight reduction of a medium processing apparatus that includes a crimper to crimp and bind multiple media and a peeler to peel off the crimped and bound media from binding teeth.

### Solution to Problem

According to an aspect of the present disclosure, a medium processing apparatus includes a conveyor to convey a medium; a stacker to stack a plurality of media conveyed by the conveyor; and a crimper to press and deform the plurality of media stacked on the stacker to bind the plurality of media. The crimper includes first binding teeth on one side with respect to the plurality of media stacked on the stacker in a thickness direction of the plurality of media stacked on the stacker; second binding teeth on another side with respect to the plurality of media stacked on the stacker in the thickness direction, the second binding teeth being movable between a pinching position at which the second binding teeth pinch the plurality of media with the first binding teeth and a retracted position at which the second binding teeth are retracted from the pinching position; a peeler to move to a separation position at which the peeler is separated from the plurality of media stacked on the stacker toward the first binding teeth and a peeling position at which the peeler peels the plurality of media stacked on the stacker from the first binding teeth; a single driving source; and a driving force transmission mechanism to move the second binding teeth between the pinching position and the retracted position by driving force of the single driving source, and to move the peeler from the separation position to the peeling position in conjunction with movement of the second binding teeth from the pinching position to the retracted position.

### Advantageous Effects of Invention

According to an aspect of the present disclosure, in a medium processing apparatus including a crimper to crimp and bind multiple media and a peeler to peel off, from binding teeth, the media crimped and bound by the crimper, jam of media can be prevented and the size and weight of the apparatus can be achieved.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating the overall configuration of an image forming system according to an embodiment of the present disclosure.

FIG. 2 is a diagram illustrating the internal structure of a post-processing apparatus according to an embodiment of the present disclosure.

FIGS. 3A and 3B are schematic views of an internal tray of the post-processing apparatus viewed in a thickness direction of sheets, according to an embodiment of the present disclosure.

FIGS. 4A and 4B are schematic diagrams illustrating a configuration of a pair of binding teeth according to an embodiment of the present disclosure.

FIG. 5 is a perspective view of a peeling plate according to an embodiment of the present disclosure.

FIGS. 6A and 6B are schematic views of a driving force transmission mechanism according to an embodiment of the present disclosure.

FIGS. 7A, 7B, 7C, 7D, 7E, and 7F are diagrams each illustrating the positional relation between a pair of binding teeth and a peeling plate according to an embodiment of the present disclosure.

FIG. 8 is a diagram illustrating a hardware configuration of a post-processing apparatus according to an embodiment of the present disclosure.

FIG. 9 is a flowchart of a binding process according to an embodiment of the present disclosure.

FIG. 10A is a schematic view of a crimper according to a comparative example of the present disclosure, and FIG. 10B is a perspective view of the crimper of FIG. 10A, illustrating a movable range of the crimper in a main scanning direction.

FIG. 11A is a schematic view of a crimper according to an embodiment of the present disclosure, and FIG. 11B is a perspective view of the crimper of FIG. 11A, illustrating a movable range of the crimper in a main scanning direction.

FIG. 12 is a schematic view of a crimper according to a first modification of the crimper illustrated in FIGS. 11A and 11B.

FIG. 13 is a schematic view of a crimper according to a second modification of the crimper illustrated in FIGS. 11A and 11B.

FIGS. 14A, 14B, and 14C are schematic views of a crimper according to a third modification of the crimper illustrated in FIGS. 11A and 11B.

### DESCRIPTION OF EMBODIMENTS

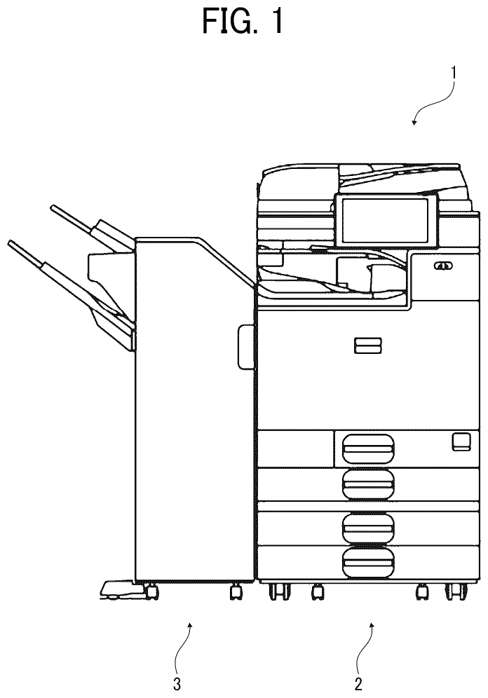

A description is given below of an image forming system 1 according to an embodiment of the present disclosure, with reference to the drawings. FIG. 1 is a diagram illustrating the overall configuration of the image forming system 1. The image forming system 1 has the function of forming an image on a sheet P as a sheet-shaped medium and performing post-processing on the sheet P on which the image is formed. As illustrated in FIG. 1, the image forming system 1 includes an image forming apparatus 2 and a post-processing apparatus 3 that serves as a medium processing apparatus.

The image forming apparatus 2 forms an image on a sheet P and ejects the sheet P, on which the image has been formed, to the post-processing apparatus 3. The image forming apparatus 2 includes, for example, a tray that holds sheets P, a conveyor that conveys a sheet P from the sheets P held in the tray, and an image forming device that forms an image on the sheet P conveyed by the conveyor. The image forming device may be an inkjet image forming device that forms an image with ink or an electrophotographic image forming device that forms an image with toner. Since the image forming apparatus 2 of FIG. 1 has a known configuration, a detailed description of the configuration and functions of the image forming apparatus 2 is omitted.

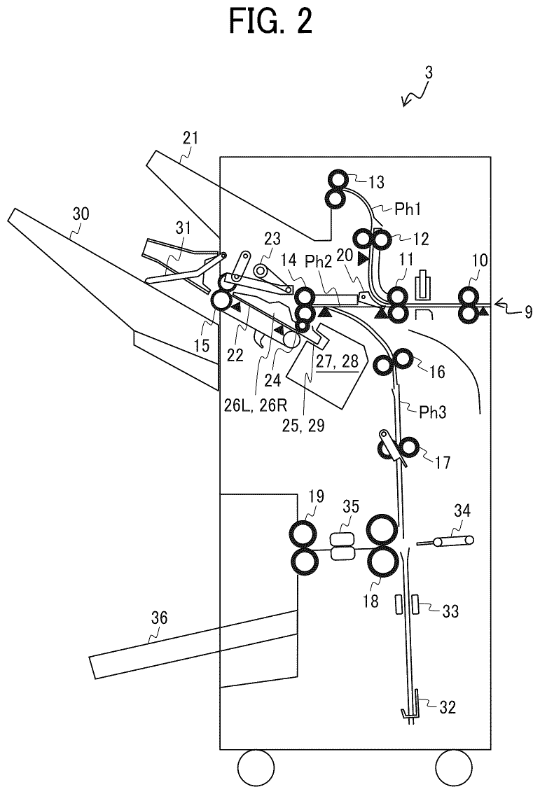

FIG. 2 is a diagram illustrating an internal configuration of the post-processing apparatus 3, according to an embodiment of the present disclosure. The post-processing apparatus 3 performs post-processing on a sheet P on which an image is formed by the image forming apparatus 2. The post-processing according to the present embodiment is binding as a process to bind sheets P, on which images have been formed, as a bundle of sheets P. In the following description, the bundle of sheets P may be referred to as a “sheet bundle Pb” (media bundle). More specifically, the binding according to the present embodiment is so-called “crimping” in which a sheet bundle Pb is pressed and deformed without using staples or a binding needle. The binding includes edge binding and saddle binding. The edge binding is a process to bind an edge of a sheet bundle Pb. The saddle binding is a process to bind the center of a sheet bundle Pb.

The post-processing apparatus 3 includes conveyance roller pairs 10, 11, 12, 13, 14, 15, 16, 17, 18, and 19 serving as conveyors and a switching plate 20. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3.

The first conveyance passage Ph1 is a passage extending to an output tray 21 from a supply port 9 through which the sheet P is supplied from the image forming apparatus 2. The second conveyance passage Ph2 is a passage branching from the first conveyance passage Ph1 at a position between the conveyance roller pair 11 and the conveyance roller pair 14 in a conveyance direction and extending to an output tray 30 via an internal tray 22. The third conveyance passage Ph3 is a passage branching from the first conveyance passage Ph1 at a position between the conveyance roller pair 11 and the conveyance roller pair 14 in the conveyance direction and extending to an output tray 36.

The switching plate 20 is disposed at a branching position of the first conveyance passage Ph1 and the second conveyance passage Ph2. The switching plate 20 can be switched between a first position and a second position. The switching plate 20 in the first position guides the sheet P to be ejected to the output tray 21 through the first conveyance passage Ph1. The switching plate 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes multiple sensors that detect the position of the sheet P in the first conveyance passage Ph1, the second conveyance passage Ph2, and the third conveyance passage Ph3. Each of the sensors is indicated by a black triangle mark in FIG. 2.

The post-processing apparatus 3 includes the output tray 21. The output tray 21 supports the sheet P discharged through the first conveyance passage Ph1. Among the sheets P supplied from the image forming apparatus 2, a sheet P not subjected to the binding is ejected to the output tray 21.

The post-processing apparatus 3 includes the internal tray 22 serving as a stacker, a tapping roller 23, a return roller 24, end fences 25 serving as a conveyance-direction aligner, side fences 26L and 26R serving as widthwise aligners, a crimper 27, a staple binder 28, an ejection plate 29, the output tray 30, and a feeler 31. The internal tray 22, the tapping roller 23, the return roller 24, the end fences 25, the side fences 26L and 26R, the crimper 27, the staple binder 28, and the ejection plate 29 perform edge binding on the sheets P conveyed through the second conveyance passage Ph2. Among the sheets P supplied from the image forming apparatus 2, the sheet bundle Pb subjected to the edge binding is ejected to the output tray 30.

In the following description, the direction from the conveyance roller pair 15 toward the end fences 25 is defined as a “conveyance direction.” The direction that is orthogonal to the conveyance direction and the thickness direction of the sheet P is defined as the “main scanning direction” or the “width direction of the sheet P.”

The internal tray 22 is disposed downstream from the conveyance roller pair 15 in the conveyance direction. Multiple sheets P are sequentially conveyed on the second conveyance path Ph2 and temporarily supported and stacked on the internal tray 22. The internal tray 22 according to the present embodiment is inclined downward toward the downstream side in the conveyance direction. The tapping roller 23 is supported at an end of a rotation arm above the internal tray 22. As the rotation arm is rotated, the tapping roller 23 contacts or separates from the uppermost one of the sheets P supported on the internal tray 22. The return roller 24 is disposed above the internal tray 22 at a position downstream from the tapping roller 23 in the conveyance direction.

When the rotation arm rotates in a direction in which the tapping roller 23 moves away from the internal tray 22, the sheet P that is conveyed in the conveyance direction by the conveyance roller pair 15 enters the internal tray 22. In this state, when the rotation arm rotates in a direction in which the tapping roller 23 approaches the internal tray 22, the tapping roller 23 taps, from above, the sheet P conveyed onto the internal tray 22 by the conveyance roller pair 15. When the sheet P is tapped with the tapping roller 23, the sheet P is separated from the conveyance roller pair 15 and supported by the internal tray 22. The return roller 24 contacts the upper surface of the sheet P supported by the internal tray 22 and rotates to guide the sheet P toward the end fences 25.

The end fences 25 are disposed downstream from the internal tray 22 in the conveyance direction. The end fences 25 contact a downstream end of the sheet bundle Pb supported by the internal tray 22 in the conveyance direction and align the position of the sheet bundle Pb in the conveyance direction. The side fences 26L and 26R are disposed on both ends of the internal tray 22 in the main scanning direction. The side fences 26L and 26R are movable in the main scanning direction. The side fences 26L and 26R contact both ends of the sheet bundle Pb, which is supported by the internal tray 22, in the main scanning direction to align the position of the sheet bundle Pb in the main scanning direction.

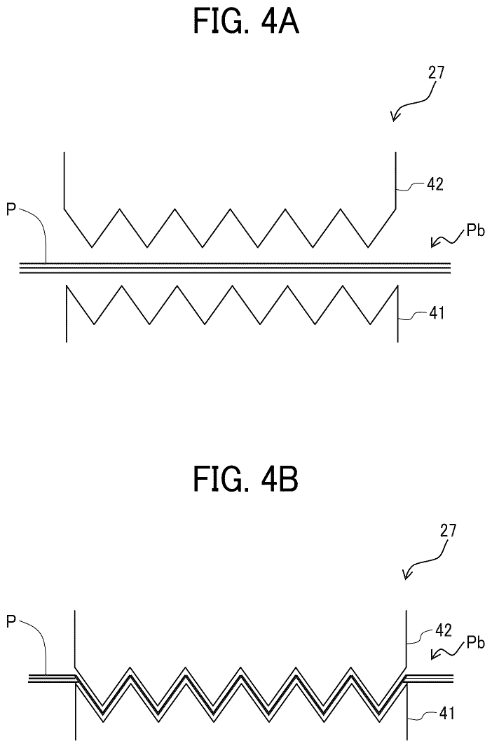

The crimper 27 pinches the binding position of the sheet bundle Pb, which is supported by the internal tray 22, by a pair of concave-convex binding teeth 41 and concave-convex binding teeth 42 (see FIG. 4) from both sides of the sheet bundle Pb in the thickness direction. As a result, the sheet bundle Pb is pressed and deformed to be crimped and bound. The staple binder 28 causes a staple(s) to pass through the binding position(s) of the sheet bundle Pb supported by the internal tray 22. Since the staple binder 28 of FIG. 2 has a known configuration, a detailed description thereof will be omitted. In some embodiments, the staple binder 28 may be omitted.

The ejection plate 29 is disposed downstream from the internal tray 22 in the conveyance direction. The ejection plate 29 is movable toward the upstream side in the conveyance direction (i.e., toward the conveyance roller pair 15) in contact with the downstream end of the sheet bundle Pb, which is supported by the internal tray 22, in the conveyance direction. When the ejection plate 29 moves to the upstream side in the conveyance direction, the ejection plate 29 causes the sheet bundle Pb subjected to the edge binding to move to the upstream side in the conveyance direction along the internal tray 22. As a result, the sheet bundle Pb, which has been subjected to the edge binding, is discharged from the internal tray 22 and enters between the conveyance roller pair 15. Then, the conveyance roller pair 15 ejects the sheet bundle Pb subjected to the edge binding to the output tray 30.

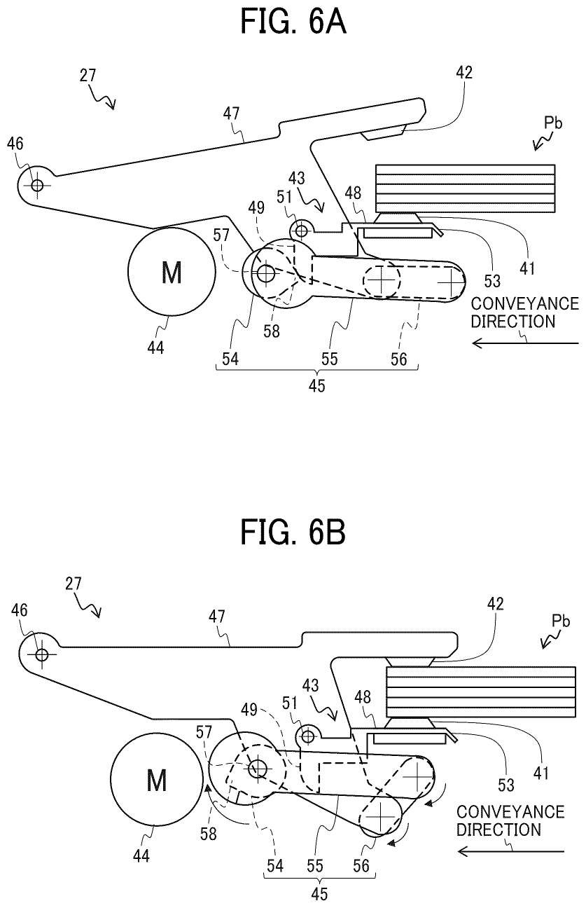

The output tray 30 is supported on an outer side face of a housing of the post-processing apparatus 3 such that the output tray 30 is movable up and down. The feeler 31 is rotatably supported above the output tray 30. An end of the feeler 31 contacts the sheet bundle Pb supported by the output tray 30. The feeler 31 detects that the height (thickness) of the sheet bundle Pb stacked on the output tray 30 has reached a threshold, and outputs the detection result to a controller 100 (see FIG. 6) described later. When the feeler 31 detects that the height of the sheet bundle Pb has reached the threshold, the controller 100 lowers the output tray 30 by a predetermined amount.

The post-processing apparatus 3 includes an end fence 32, a binder 33, a sheet folding blade 34, a puncher 35, and an output tray 36. The end fence 32, the binder 33, and the sheet folding blade 34 perform saddle binding on sheets P conveyed on the third conveyance passage Ph3. Among the sheets P supplied from the image forming apparatus 2, the sheet bundle Pb subjected to the saddle binding is ejected to the output tray 36.

The end fence 32 aligns the position of sheets P, which are sequentially conveyed through the third conveyance passage Ph3, in a conveyance direction in which the sheets P are conveyed. The end fence 32 can move between a saddle binding region at which the end fence 32 causes the center of the sheet bundle Pb to face the binder 33 and a folding position at which the end fence 32 causes the center of the sheet bundle Pb to face the sheet folding blade 34. The binder 33 binds the center of the sheet bundle Pb aligned by the end fence 32 at the saddle binding region. The sheet folding blade 34 folds the sheet bundle Pb in half while the sheet bundle Pb is supported by the end fence 32 at the folding position, and causes the convey ance roller pair 18 to nip the sheet bundle Pb. The conveyance roller pair 18 and the conveyance roller pair 19 eject the sheet bundle Pb subjected to the saddle binding to the output tray 36. The puncher 35 punches a through hole in the sheet bundle Pb conveyed by the conveyance roller pair 18 and the conveyance roller pair 19.

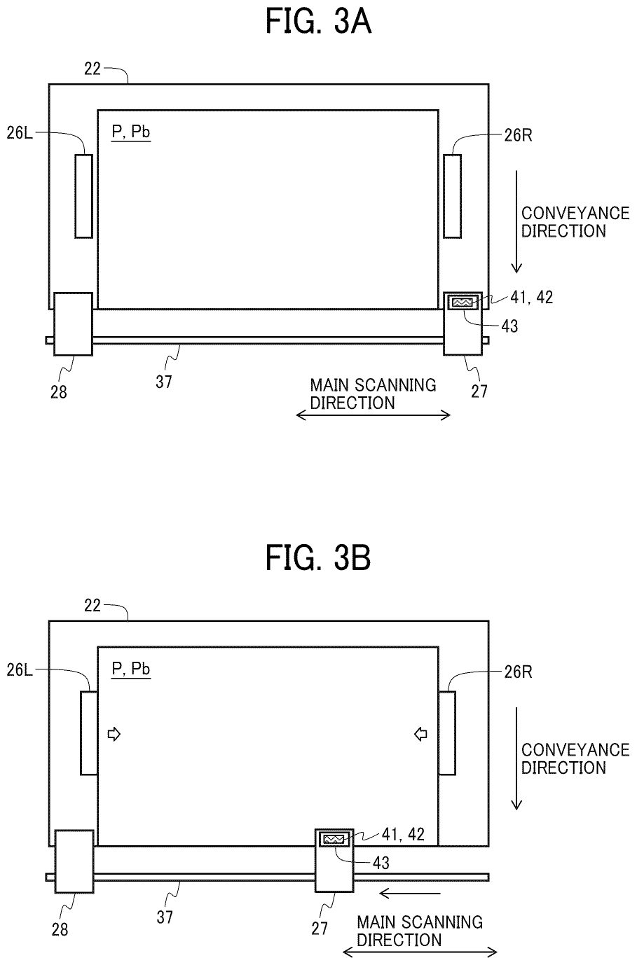

FIGS. 3A and 3B are schematic views of the internal tray 22 viewed from the thickness direction of sheets P. As illustrated in FIG. 3A, the crimper 27 and the staple binder 28 are disposed downstream from the internal tray 22 in the conveyance direction. The crimper 27 and the staple binder 28 are slidable in the main scanning direction along the surface of sheets Por a sheet bundle Pb supported by the internal tray 22.

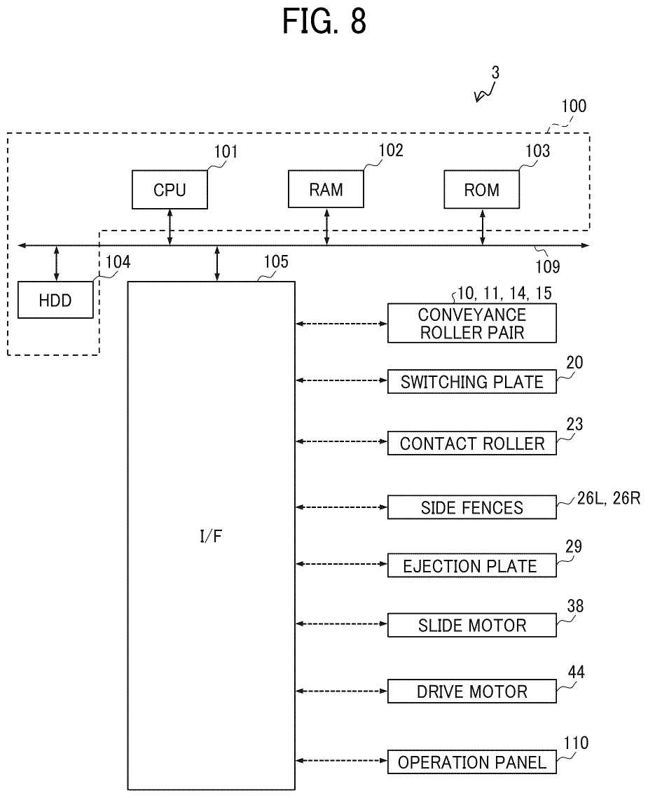

More specifically, a guide rail 37 extending in the main scanning direction is disposed downstream from the internal tray 22 in the conveyance direction. When the driving force of a slide motor 38 (see FIG. 8) is transmitted to the crimper 27, the crimper 27 slides in the main scanning direction along the surface of the sheet bundle Pb supported by the internal tray 22, i.e., along the guide rail 37. The guide rail 37 and the slide motor 38 serve as a slider. The same applies to the staple binder 28.

The crimper 27 slides between a standby position illustrated in FIG. 3A and a position facing the binding position illustrated in FIG. 3B. The standby position is a position away from sheets P supported on the internal tray 22 toward one side in the main scanning direction. The binding position is a position above the sheet bundle Pb supported by the internal tray 22. However, the specific position of the binding position is not limited to the example of FIG. 3B, and may be any position in the main scanning direction on a downstream end portion of the sheet bundle Pb in the conveyance direction.

The crimper 27 includes, for example, a pair of binding teeth 41 and binding teeth 42, a peeling plate 43 (as a first peeler), a driving motor 44 (see FIGS. 6 and 8), which serves as a driving source, and a driving force transmission mechanism 45 (see FIG. 6). Thus, the components 41 to 45 of the crimper 27 slide as a single unit.

FIGS. 4A and 4B are schematic views of the pair of binding teeth 41 and binding teeth 42. As illustrated in FIG. 4A, the pair of binding teeth 41 and binding teeth 42 are disposed to face each other in the thickness direction of the sheet bundle Pb with the sheet bundle Pb supported by the internal tray 22 interposed between the pair of binding teeth 41 and binding teeth 42. The binding teeth 41 serve as first binding teeth disposed on one side (lower side in the present embodiment) with respect to the sheet bundle Pb in the thickness direction of the sheet bundle Pb supported by the internal tray 22. The binding teeth 42 serve as second binding teeth disposed on the other side (upper side in the present embodiment) with respect to the sheet bundle Pb in the thickness direction of the sheet bundle Pb supported by the internal tray 22. Alternatively, the binding teeth 42 may be the first binding teeth, and the binding teeth 41 may be the second binding teeth. The specific shapes of the binding teeth 41 and binding teeth 42 are not limited to the example illustrated in FIGS. 4A and 4B.

When the pair of binding teeth 41 and binding teeth 42 is seen in plan view from the thickness direction of the sheet bundle Pb supported by the internal tray 22, the pair of binding teeth 41 and binding teeth 42 has a rectangular outer shape. The binding teeth 41 and the binding teeth 42 have respective serrate faces facing each other. The serrate face of each of the binding teeth 41 and the binding teeth 42 includes concave portions and convex portions that are alternately formed. The concave portions and the convex portions of the binding teeth 41 are shifted in position from the concave portions and the convex portions of the binding teeth 42 such that the binding teeth 41 are engaged with the binding teeth 42. The binding teeth 41 and the binding teeth 42 contact and separate from each other when the driving force of the driving motor 44 is transmitted to binding teeth 41 and the binding teeth 42 via the driving force transmission mechanism 45.

In the process in which the sheets P constituting the sheet bundle Pb are supplied to the internal tray 22, at least one of the binding teeth 41 and the binding teeth 42 is away from the sheets P as illustrated in FIG. 4A. When all the sheets P constituting the sheet bundle Pb are supported by the internal tray 22, as illustrated in FIG. 4B, the driving motor 44 is driven to cause the binding teeth 41 and the binding teeth 42 to mesh with each other to pinch the sheet bundle Pb in the thickness direction. As a result, the sheet bundle Pb supported by the internal tray 22 is pressed and deformed, so that the sheet bundle Pb is crimped and bound.

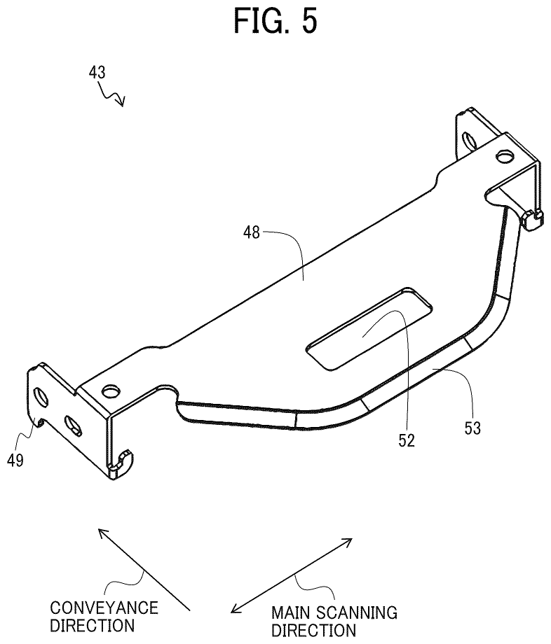

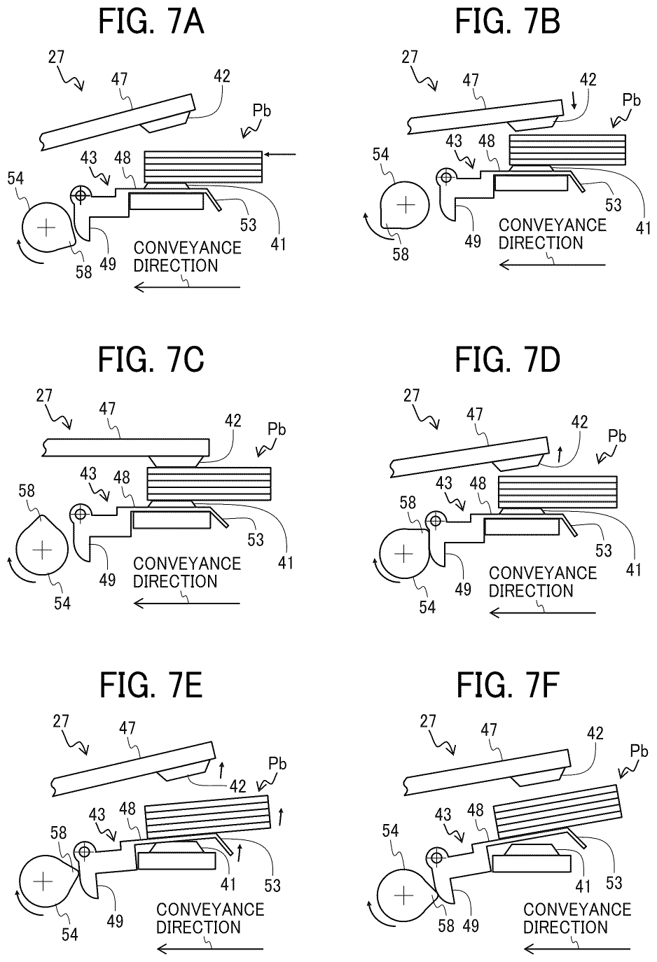

FIG. 5 is a perspective view of the peeling plate 43 according to an embodiment of the present disclosure. FIGS. 6A and 6B are schematic views of the driving force transmission mechanism 45 according to an embodiment of the present disclosure. FIGS. 7A, 7B, 7C, 7D, 7E, and 7F are diagrams each illustrating a positional relation between the pair of binding teeth 41 and binding teeth 42 and the peeling plate 43.

As illustrated in FIGS. 6A and 6B, the binding teeth 41 are fixed to the frame of the crimper 27. On the other hand, the binding teeth 42 are attached to a rotation arm 47 by a support shaft 46 extending in the main scanning direction. The rotation arm 47 is rotatably supported by a frame of the crimper 27. When the driving force of the driving motor 44 is transmitted to the binding teeth 42 via the driving force transmission mechanism 45, the binding teeth 42 attached to the rotation arm 47 move (rotate) between the retracted position illustrated in FIG. 6A and the pinching position illustrated in FIG. 6B.

The pinching position is a position at which the binding teeth 42 and the binding teeth 41 pinch the sheet bundle Pb between the binding teeth 42 and the binding teeth 41 to crimp and bind the sheet bundle Pb. The retracted position is a position at which the binding teeth 42 are retracted from the pinching position. More specifically, the retracted position is a position at which the binding teeth 42 are further away from the binding teeth 41 than the pinching position, to release the pinching of the sheet bundle Pb. In other words, the retracted position is a position at which the gap between the binding teeth 41 and the binding teeth 42 is wider than that at the pinching position.

When the pair of binding teeth 41 and binding teeth 42 pinching the sheet bundle Pb are separated from each other, the peeling plate 43 performs the role of peeling the press-bound sheet bundle Pb from the binding teeth 41. The peeling plate 43 is formed by, for example, bending a flat plate. As illustrated in FIG. 5, the peeling plate 43 includes a peeling portion 48 and link arms 49.

As illustrated in FIGS. 6A and 6B, the peeling plate 43 is disposed on the side opposite to the binding teeth 42 across the sheet bundle Pb supported by the internal tray 22. Further, the peeling plate 43 is rotatably supported by the frame of the crimper 27 by a support shaft 51 extending in the main scanning direction. When the driving force of the driving motor 44 is transmitted via the driving force transmission mechanism 45, the peeling plate 43 moves or rotates between the first separation position illustrated in FIGS. 7A to 7D and the first peeling position illustrated in FIG. 7F.

The first separation position is a position at which the peeling portion 48 is moved away from the sheet bundle Pb supported by the internal tray 22 toward the binding teeth 41. The first peeling position is a position at which the sheet bundle Pb supported by the internal tray 22 is pressed toward the binding teeth 42 to peel off the sheet bundle Pb from the binding teeth 41.

The peeling portion 48 is a plate-shaped portion that contacts and separates from the sheet bundle Pb supported by the internal tray 22. As illustrated in FIG. 5, an opening 52 penetrating in the thickness direction is formed in the peeling portion 48. The opening 52 has a size that allows the binding teeth 41 to protrude and retract through the opening 52. As illustrated in FIGS. 7A to 7D, when the peeling plate 43 is at the first separation position, the binding teeth 41 protrude toward the sheet bundle Pb supported by the internal tray 22 through the opening 52. As illustrated in FIG. 7F, when the peeling plate 43 is at the first peeling position, the binding teeth 41 are retracted, through the opening 52, to the side opposite to the sheet bundle Pb supported by the internal tray 22 with respect to the peeling plate 43.

As illustrated in FIG. 5, a guide face 53 is formed at a distal end of the peeling portion 48 (i.e., an upstream end of the peeling portion 48 in the conveyance direction when the peeling portion 48 is attached to the crimper 27). As illustrated in FIGS. 6A and 6B, the guide face 53 faces the sheets P supported by the internal tray 22. In addition, the guide face 53 is inclined such that the distance between the guide face 53 and the sheets P supported by the internal tray 22 gradually increases toward the upstream side in the conveyance direction. When the peeling portion 48 is at the first separation position, the guide face 53 guides the sheet P, which is conveyed toward the internal tray 22 by the conveyance roller pair 15 and the tapping roller 23, into between the pair of binding teeth 41 and binding teeth 42.

When a projecting portion 58 of a cam 54, which is described later, contacts and separates from the link arm 49, the peeling plate 43 is rotated. As illustrated in FIGS. 7A to 7D, when the projecting portion 58 is separated from the link arm 49, the peeling plate 43 is disposed at the first separation position. As illustrated in FIGS. 7E and 7F, when the cam 54 rotates with the projecting portion 58 being in contact with the link arm 49, the peeling plate 43 rotates or moves from the first separation position toward the first peeling position.

The driving force transmission mechanism 45 moves the binding teeth 42 between the pinching position and the retracted position by the driving force of the driving motor 44. The driving force transmission mechanism 45 moves the peeling plate 43 from the first separation position to the first peeling position in conjunction with the movement of the binding teeth 42 from the pinching position to the retracted position by the driving force of the driving motor 44. In other words, the binding teeth 42 and the peeling plate 43 are moved in conjunction with each other by the driving force of the single driving motor 44. As illustrated in FIGS. 6A and 6B, the driving force transmission mechanism 45 includes, for example, the cam 54, an outer link 55, and an inner link 56.

The cam 54 is coupled to the output shaft of the driving motor 44. The cam 54 is rotatably supported on the frame of the crimper 27 by a support shaft 57 extending in the main scanning direction. The cam 54 is rotated in one direction (e.g., clockwise in FIG. 6) by the driving force of the driving motor 44. The cam 54 has the projecting portion 58 projecting outward in the radial direction at a part (one place) in the circumferential direction.

One end of the outer link 55 is coupled to the cam 54 and the other end of the outer link 55 is connected to the inner link 56. One end of the inner link 56 is coupled to the outer link 55, and the other end of the inner link 56 is coupled to the rotation arm 47. The outer link 55 and the inner link 56, which serve as links, transmit the rotation of the cam 54 to the rotation arm 47. More specifically, the outer link 55 and the inner link 56 move the binding teeth 42, which are attached to the rotation arm 47, between the pinching position and the retracted position in conjunction with the rotation of the cam 54.

For example, when the cam 54 rotates 180° clockwise from the position of FIG. 7A, the binding teeth 42 move from the retracted position to the pinching position. When the cam 54 further rotates by 180° and returns to the position illustrated in FIG. 7A, the binding teeth 42 move from the pinching position to the retracted position. In other words, the binding teeth 42 reciprocate once between the retracted position and the pinching position while the cam 54 rotates once in the clockwise direction. The configuration for transmitting the driving force of the driving motor 44 to the binding teeth 42 is not limited to any particular configuration as long as the movement of the binding teeth 42 between the pinching position and the retracted position can be achieved.

As illustrated in FIGS. 7A to 7C, while the binding teeth 42 are moving from the retracted position to the pinching position, the projecting portion 58 of the cam 54 is separated from the link arm 49. In other words, the peeling plate 43 is disposed at the first separation position while the binding teeth 42 are moving from the retracted position to the pinching position. As a result, as illustrated in FIG. 7C, the sheet bundle Pb is pinched and bound by the binding teeth 41, which protrudes toward the sheet bundle Pb through the opening 52, and the binding teeth 42 at the pinching position. Thus, the sheet bundle Pb is crimped and bound.

Further, as illustrated in FIG. 7D, after the binding teeth 42 start to move from the pinching position to the retracted position, the projecting portion 58 of the cam 54 contacts the link arm 49. Then, as illustrated in FIGS. 7D to 7F, when the cam 54 rotates clockwise with the projecting portion 58 being in contact with the link arm 49, the link arm 49 is pressed by the projecting portion 58. As a result, the peeling plate 43 moves from the first separation position to the first peeling position. In other words, the peeling plate 43 moves from the first separation position to the first peeling position in conjunction with the movement of the binding teeth 42 from the pinching position to the retracted position. Further, when the cam 54 further rotates from the position illustrated in FIG. 7F and the projecting portion 58 separates from the link arm 49, the peeling plate 43 at the first peeling position returns to the first separation position by its own weight.

FIG. 8 is a diagram illustrating a hardware configuration of the post-processing apparatus 3, according to an embodiment of the present disclosure. As illustrated in FIG. 8, the post-processing apparatus 3 includes a central processing unit (CPU) 101, a random access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is a computing device and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3 processes, for example, a control program stored in the ROM 103 and an information processing program (application program) loaded into the RAM 102 from a storage medium such as the HDD 104, through the computing function of the CPU 101. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, and the HDD 104 construct a controller 100 that controls the operation of the post-processing apparatus 3.

The I/F 105 is an interface that connects the conveyance roller pairs 10, 11, 14, and 15, the switching plate 20, the tapping roller 23, the side fences 26L and 26R, the ejection plate 29, the slide motor 38, the driving motor 44, and the operation panel 110 to the common bus 109. The controller 100 operates the conveyance roller pairs 10, 11, 14, and 15, the switching plate 20, the tapping roller 23, the side fences 26L and 26R, the ejection plate 29, the slide motor 38, and the driving motor 44 through the I/F 105. Although FIG. 8 illustrates the components that execute the edge binding, the components that execute the saddle binding are controlled by the controller 100 in the same or similar manner as in the case of the components that execute the edge binding.

The operation panel 110 includes an operation device that receives instructions from an operator and a display serving as an indicator that notifies the operator of information. The operation device includes, for example, physical input buttons and a touch panel overlaid on a display. The operation panel 110 acquires information from the operator through the operation device and provides the operator with information through the display. Examples of the indicator are not limited to the display and may be, for example, a light emitting diode (LED) lamp or a speaker.

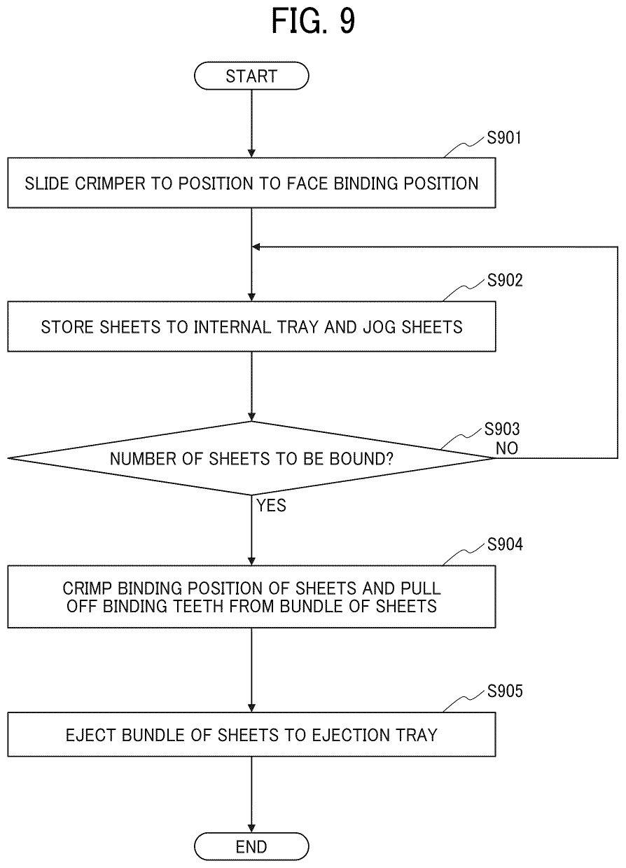

FIG. 9 is a flowchart of a binding process according to an embodiment of the present disclosure. The controller 100 starts the binding process illustrated in FIG. 9, for example, when an execution instruction of the binding process, which is referred to as a binding instruction below, is acquired from the image forming apparatus 2. The binding instruction includes, for example, the number of sheets P constituting the sheet bundle Pb, which is referred to as the number of sheets to be bound, and the binding position on the sheet bundle Pb. As illustrated in FIG. 3A, it is assumed that the crimper 27 is located at the standby position at the start of the binding process.

In step S901, the controller 100 drives the slide motor 38 to slide the crimper 27 to a position at which the crimper 27 can face the binding position. In step S902, the controller 100 rotates the conveyance roller pairs 10, 11, 14, and 15 to store the sheet P on which the image is formed by the image forming apparatus 2 in the internal tray 22. The controller 100 also moves the side fences 26L and 26R to align the position of the sheet bundle Pb, which is supported on the internal tray 22, in the main scanning direction (or performs so-called jogging on the sheet bundle Pb).

In step S903, the controller 100 determines whether the number of sheets P stored in the internal tray 22 has reached the number of sheets to be bound as instructed by the binding instruction. When the controller 100 determines that the number of sheets P stored in the internal tray 22 has not reached the number of sheets to be bound (No in step S903), the controller 100 executes the process of step S902 again.

Alternatively, when the controller 100 determines that the number of sheets P stored in the internal tray 22 reaches the number of sheets to be bound (Yes in step S903), the controller 100 drives the driving motor 44 to rotate the cam 54 clockwise by one rotation (step S904). Thus, as described with reference to FIGS. 6A to 7F, the binding teeth 41 and the binding teeth 42 are engaged with each other to crimp and bind the sheet bundle Pb, and the peeling plate 43 peels the binding teeth 41 from the sheet bundle Pb in conjunction with the separation of the binding teeth 41 and the binding teeth 42.

Then, the controller 100 causes the crimped sheet bundle Pb to be ejected to the output tray 30. More specifically, the controller 100 moves the ejection plate 29 upstream in the main scanning direction to cause the conveyance roller pair 15 to nip the sheet bundle Pb. Further, in step S905, the controller 100 rotates the conveyance roller pair 15 to eject the sheet bundle Pb to the output tray 30. Further, as illustrated in FIG. 3A, the controller 100 causes the crimper 27 to move to the standby position.

According to the above-described embodiment, the following operational effects are obtained.

According to the above-described embodiment, the peeling plate 43 located at the separation position can provide a wider gap between the pair of binding teeth 41 and binding teeth 42 than the configuration described in PTL 1 (Japanese Unexamined Patent Application Publication No. 2015-064707). Such a configuration allows the sheet P conveyed toward the internal tray 22 by the conveyance roller pair 15 and the tapping roller 23 to smoothly enter between the pair of binding teeth 41 and binding teeth 42. As a result, even when a large number of sheets P are received between the pair of binding teeth 41 and binding teeth 42, jamming of the sheets P can be prevented. In addition, the guide face 53 provided with the peeling plate 43 can further prevent jamming of the sheets P.

In addition, according to the above-described embodiment, the binding teeth 42 and the peeling plate 43 are moved by the single driving motor 44. Such a configuration can reduce the number of motors as compared with the configuration of PTL 2 (Japanese Unexamined Patent Application Publication No. 2020-147005. Accordingly, the size and weight of the crimper 27 (i.e., the post-processing apparatus 3) can be achieved. As a result, the manufacturing cost of the post-processing apparatus 3 can be reduced.

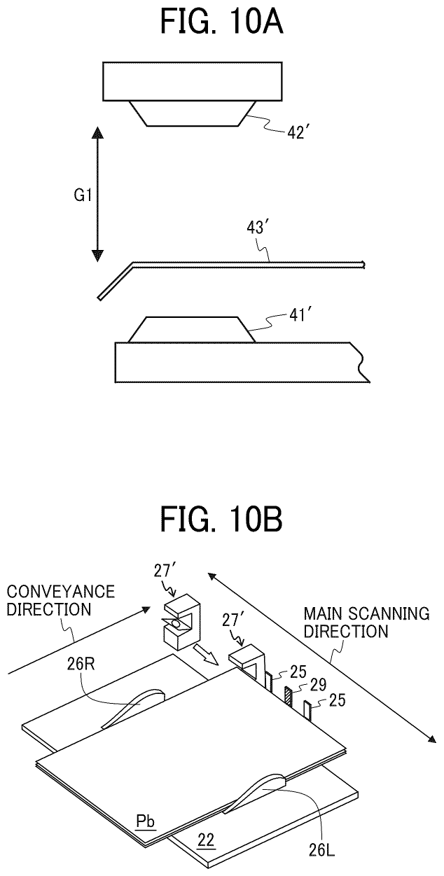

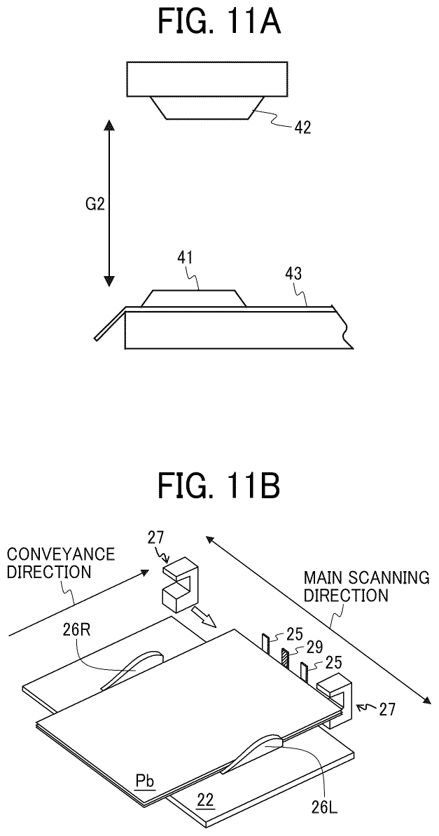

Further, according to the above-described embodiment, the crimper 27 is slid in the main scanning direction by the slide motor 38. Such a configuration allows the sheet bundle Pb to be crimped and bound at any suitable binding position in the main scanning direction. FIG. 10A is a schematic view of a crimper 27′ according to a comparative example of the present disclosure. FIG. 10B is a perspective view of the crimper 27′ of FIG. 10A, illustrating a movable range of the crimper 27′ in a main scanning direction. FIG. 11A is a schematic view of the crimper 27 according to the present embodiment. FIG. 11B is a perspective view of the crimper 27 of FIG. 11A, illustrating a movable range of the crimper 27 in a main scanning direction.

As illustrated in FIG. 10A, if the gap G1 between binding teeth 42′ and a peeling plate 43′ is narrow, the crimper 27′ interferes with an end fence 25 and an ejection plate 29 when the crimper 27′ slides in the main scanning direction. Accordingly, as illustrated in FIG. 10B, the movable range of the crimper 27′ according to the comparative example in the main scanning direction is limited to the range from the standby position to the end fence 25 closest to the standby position.

By contrast, according to the present embodiment, the peeling plate 43 is movable to the separation position. As illustrated in FIG. 11A, the gap G2 between the binding teeth 42 and the peeling plate 43 can be made wider than the gap G1 of the comparative example illustrated in FIG. 10A. Thus, when the crimper 27 slides in the main scanning direction, the crimper 27 can be prevented from interfering with the end fence 25 and the ejection plate 29. Accordingly, as illustrated in FIG. 11B, the movable range of the crimper 27 according to the present embodiment in the main scanning direction extends to the entire region of the sheets P supported by the internal tray 22 in the main scanning direction.

In addition, according to the above-described embodiment, the weight of the crimper 27 is reduced, and thus the load of the slide motor 38 can be reduced. For example, since the crimper 27 can be slid more quickly with the same amount of electric power, the productivity of the binding process is increased. Alternatively, since the amount of electric power in the case where the crimper 27 is slid at the same speed is reduced, power consumption can be reduced. Further, since the post-processing apparatus 3 can be operated with reduced power consumption, deterioration of the driving motor 44 can be reduced, and thus the lifetime of the post-processing apparatus 3 is extended.

According to the above-described embodiment, when the peeling plate 43 is moved between the first separation position and the first peeling position, the binding teeth 41 are protruded and retracted through the opening 52. Thus, the crimper 27 can be simplified and downsized as compared with, for example, the configuration in which the peeling plate 43 is disposed at a position at which the peeling plate 43 avoids the binding teeth 41. As a result, the manufacturing cost of the post-processing apparatus 3 is further reduced.

In addition, since the operations of the binding teeth 42 and the peeling plate 43 are coordinated with each other by the cam 54, stable coordination can be achieved with a simple configuration as compared with the case where the operations are coordinated with each other by software control. The operation timing of the binding teeth 42 and the peeling plate 43 can be easily changed by changing the shape or phase of the cam 54.

For example, the driving force transmission mechanism 45 according to the above-described embodiment causes the peeling plate 43 to start moving from the first separation position to the first peeling position after the binding teeth 42 start moving from the pinching position to the retracted position. Accordingly, the peeling plate 43 moves to the first peeling position after the pinching of the sheet bundle Pb by the binding teeth 41 and the binding teeth 42 is released. Thus, the sheet bundle Pb can be reliably peeled from the binding teeth 41.

Alternatively, for example, the driving force transmission mechanism 45 may start moving the peeling plate 43 from the first separation position to the first peeling position before the binding teeth 42 start moving from the pinching position to the retracted position. Accordingly, the time required to peel the sheet bundle Pb from the binding teeth 41 is shortened, and the productivity of the binding process is enhanced.

In the above-described embodiment, the example of the image forming system 1 including the image forming apparatus 2 and the post-processing apparatus 3 has been described. However, a medium processing apparatus according to an embodiment of the present disclosure may be implemented as the post-processing apparatus 3 alone. Further, an image forming apparatus according to an embodiment of the present disclosure may be implemented by mounting the internal tray 22 and the crimper 27 on the image forming apparatus 2 including the conveyors and the image forming device.

### First Modification

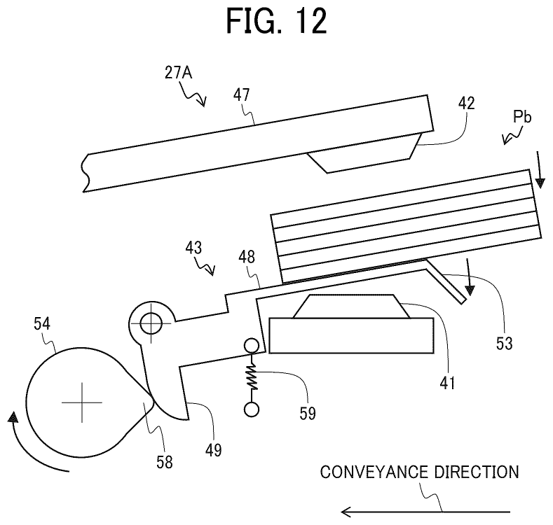

FIG. 12 is a diagram illustrating a crimper 27A according to a first modification of the above-described embodiments of the present disclosure. The crimper 27A according to the first modification is described below with reference to FIG. 12. Detailed description may be omitted of common features of the above-described embodiments and the present modification. The following description is focused on the differences between the above-described embodiments and the present modification. As illustrated in FIG. 12, the crimper 27A according to the first modification is different from the crimper 27 in that the crimper 27A further includes a coil spring 59 serving as a biasing member, and is the same as the crimper 27 in the other configurations.

The coil spring 59 is coupled at one end to the frame of the crimper 27A and at the other end to the peeling plate 43. The coil spring 59 biases the peeling plate 43 toward the first separation position. Thus, when the cam 54 rotates with the projecting portion 58 contacting the link arm 49, the peeling plate 43 moves from the first separation position to the first peeling position against the biasing force of the coil spring 59. By contrast, when the projecting portion 58 is separated from the link arm 49, the peeling plate 43 returns from the first peeling position to the first separation position by the biasing force of the coil spring 59.

According to the first modification, the peeling plate 43 can return faster from the first peeling position to the first separation position and more appropriately return to the first separation position than in the case where the peeling plate 43 returns from the first peeling position to the first separation position by its own weight.

### Second Modification

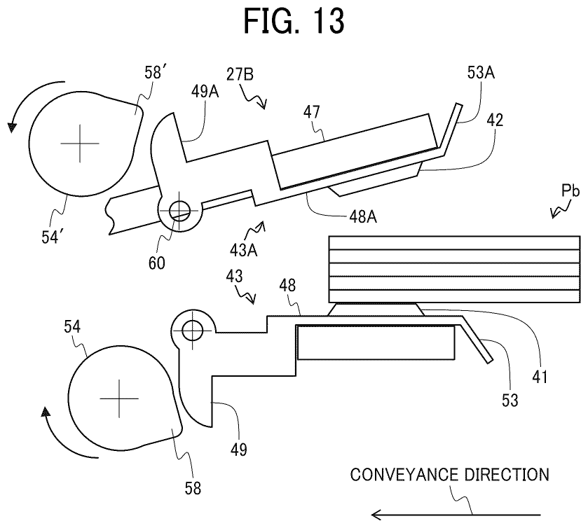

FIG. 13 is a diagram illustrating a crimper 27B according to a second modification of the above-described embodiments of the present disclosure. The crimper 27B according to the second modification is described below with reference to FIG. 13. Detailed description may be omitted of common features of the above-described embodiments and the present modification. The following description is focused on the differences between the above-described embodiments and the present modification. As illustrated in FIG. 13, the crimper 27B according to the second modification is different from the crimper 27 in that the crimper 27B further includes a peeling plate 43A serving as a second peeler and a cam 54′, and is the same as the crimper 27 in the other configurations.

The peeling plate 43A is supported by a support shaft 60 extending in the main scanning direction at a position closer to the binding teeth 42 than the sheet bundle Pb supported by the internal tray 22. The peeling plate 43A is rotatable relative to the rotation arm 47. The peeling plate 43A is movable between the second separation position illustrated in FIG. 13 and a second peeling position. The second separation position is a position separated from the sheet bundle Pb supported by the internal tray 22. The second peeling position is a position at which the sheet bundle Pb supported by the internal tray 22 is pressed and the sheet bundle Pb is peeled off from the binding teeth 42. The specific configuration of the peeling plate 43A is the same as that of the peeling plate 43 except that the peeling plate 43A is turned upside down and disposed on the same side as the binding teeth 42 with respect to the sheet bundle Pb.

The cam 54′ transmits the driving force of the driving motor 44 to the peeling plate 43A to move the peeling plate 43A between the second separation position and the second peeling position. The driving force of the driving motor 44 is distributed to the cam 54 and the cam 54′ via, for example, gears, pulleys, and timing belts. In other words, the driving force transmission mechanism according to the second modification moves the peeling plate 43 from the first separation position to the first peeling position and moves the peeling plate 43A from the second separation position to the second peeling position, in conjunction with the movement of the binding teeth 42 from the pinching position to the retracted position by the driving force of the single driving motor 44.

The operation timing of the peeling plate 43 and the peeling plate 43A can be adjusted by the shapes and phases of the cams 54 and 54′. For example, the driving force transmission mechanism according to the second modification may start moving the peeling plate 43A from the second separation position to the second peeling position before starting moving the peeling plate 43 from the first separation position to the first peeling position. However, the operation timing of the peeling plates 43 and 43A is not limited to the above-described example.

According to the second modification, the binding teeth 41 and the binding teeth 42 can be appropriately peeled off from the sheet bundle Pb. Further, since the peeling plates 43 and 43 A are operated by the driving force of the single driving motor 44, the size and weight of the crimper 27B can be reduced.

### Third Modification

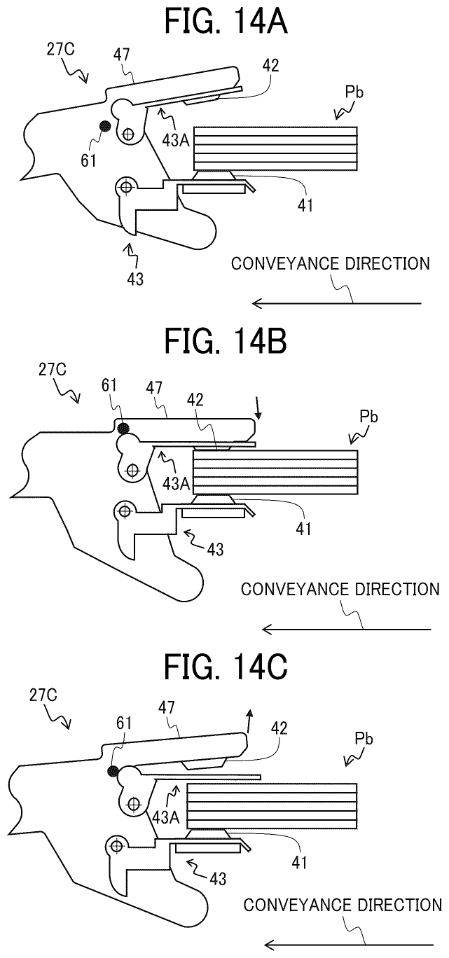

FIGS. 14A, 14B, and 14C are diagrams each illustrating a crimper 27C according to a third modification of the above-described embodiments of the present disclosure. The crimper 27C according to the third modification is described below with reference to FIGS. 14A to 14C. Detailed description may be omitted of common features of the above-described embodiments and the second modification. The following description is focused on the differences between the above-described embodiments and the present modification. As illustrated in FIGS. 14A to 14C, the crimper 27C according to the third modification is different from the crimper 27B in that a protrusion 61 is included instead of the cam 54′, and is the same as the crimper 27B in the other configurations.

The protrusion 61 is attached to the rotation arm 47. As the rotation arm 47 rotates, the protrusion 61 contacts or separates from the peeling plate 43A. More specifically, the protrusion 61 is separated from the peeling plate 43A while the binding teeth 42 move from the retracted position to the pinching position. Thus, as illustrated in FIGS. 14A and 14B, the peeling plate 43 A rotates from the second separation position toward the second peeling position by the rotation of the rotation arm 47.

In addition, as illustrated in FIG. 14B, the protrusion 61 contacts the peeling plate 43A when the binding teeth 42 reach the pinching position. When the binding teeth 42 move from the pinching position to the retracted position in this state, as illustrated in FIG. 14C, the peeling plate 43A contacting the protrusion 61 is held at the second peeling position against the rotation of the rotation arm 47. Further, the protrusion 61 separates from the peeling plate 43A when the binding teeth 42 reach the retracted position. Accordingly, the peeling plate 43A rotates from the second peeling position toward the second separation position. The crimper 27C according to the third modification may include a biasing member that biases the peeling plate 43A toward the second separation position as in the first modification.

According to the third modification, the peeling plate 43A can be operated with a simpler configuration than the configuration of the second modification. Thus, the number of components of the crimper 27C is reduced, so that the manufacturing cost and the management cost of components can be reduced. In some embodiments, the protrusion 61 according to the third modification may be provided to operate the peeling plate 43.

In addition, embodiments of the present disclosure can be applied not only to the crimper 27 that performs the edge binding but also to the binder 33 that performs the saddle binding.

The above-described control method may be implemented by, for example, a program. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

Embodiments of the present disclosure are not limited to the above-described embodiments and modifications, and numerous additional modifications and variations are possible in light of the teachings. The technical contents included in the technical ideas described in the appended claims are included within the technical scope of the appended claims. The above-described embodiments and modifications are some examples, and various modifications and variations can be practiced from such examples by those skilled in the art. Such modifications and variations are included in the technical scope described in the appended claims.

A description is given below of some aspects of the present disclosure.

### First Aspect

A medium processing apparatus includes: a conveyor to convey a medium; a stacker to stack a plurality of media conveyed by the conveyor, and a crimper to press and deform the plurality of media stacked on the stacker to bind the plurality of media. The crimper includes: first binding teeth on one side with respect to the plurality of media stacked on the stacker in a thickness direction of the plurality of media stacked on the stacker; second binding teeth on another side with respect to the plurality of media stacked on the stacker in the thickness direction, the second binding teeth being movable between a pinching position at which the second binding teeth pinch the plurality of media with the first binding teeth and a retracted position at which the second binding teeth are retracted from the pinching position; a first peeler to move to a first separation position at which the first peeler is separated from the plurality of media stacked on the stacker toward the first binding teeth and a first peeling position at which the first peeler peels the plurality of media stacked on the stacker from the first binding teeth; a single driving source; and a driving force transmission mechanism to move the second binding teeth between the pinching position and the retracted position by driving force of the single driving source, and to move the first peeler from the first separation position to the first peeling position in conjunction with movement of the second binding teeth from the pinching position to the retracted position.

### Second Aspect

In the medium processing apparatus according to the first aspect, the crimper further includes a second peeler that is movable to a second separation position at which the crimper is separated from the plurality of media stacked on the stacker toward the second binding teeth and a second peeling position at which the crimper peels the plurality of media stacked on the stacker from the second binding teeth.

### Third Aspect

In the medium processing apparatus according to the second aspect, the driving force transmission mechanism moves the second peeler from the second separation position to the second peeling position in conjunction with the movement of the second binding teeth from the pinching position to the retracted position by the driving force of the single driving source.

### Fourth Aspect

In the medium processing apparatus according to the third aspect, the driving force transmission mechanism causes the second peeler to start moving from the second separation position to the second peeling position before causing the first peeler to start moving from the first separation position to the first peeling position.

### Fifth Aspect

The medium processing apparatus according to the third or fourth aspect further includes a rotation arm to be rotated by driving force of the single driving source. The second binding teeth are attached to the rotation arm such that the second binding teeth rotates between the pinching position and the retracted position. The rotation arm includes a protrusion to contact and separate from the second peeler. The second peeler separates from the protrusion while the second binding teeth move from the retracted position to the pinching position, and rotates from the second separation position to the second peeling position by rotation of the rotation arm. The second peeler contacts the protrusion in a process in which the second binding teeth move from the pinching position to the retracted position, and is held at the second peeling position.

### Sixth Aspect

In the medium processing apparatus according to any one of the first to fifth aspects, the driving force transmission mechanism includes: a cam having a projecting portion at a part of the cam in a circumferential direction of the cam, the cam to be rotated by driving force of the single driving source; and a link to move the second binding teeth between the pinching position and the retracted position in conjunction with rotation of the cam. The first peeler is pressed by the projecting portion of the cam in a process in which the second binding teeth move from the pinching position to the retracted position, to move from the first separation position to the first peeling position.

### Seventh Aspect

In the medium processing apparatus according to any one of the first to sixth aspects, the crimper includes a biasing member to bias the first peeler toward the first separation position.

### Eighth Aspect

In the medium processing apparatus according to any one of the first to seventh aspects, the first peeler has a guide face to guide the medium to between the first binding teeth and the second binding teeth, and the guide face is at an upstream end of the first peeler in a conveyance direction in which the medium is conveyed by the conveyor.

### Ninth Aspect

In the medium processing apparatus according to any one of the first to eighth aspects, the first peeler has a plate shape having an opening through which the first binding teeth are to protrude and retract. When the first peeler is located at the first separation position, the first binding teeth protrude through the opening toward the plurality of media stacked on the stacker. When the first peeler is located at the first peeling position, the first binding teeth are retracted through the opening to a side opposite to the plurality of media stacked on the stacker.

### Tenth Aspect

In the medium processing apparatus according to any one of the first to ninth aspects, the driving force transmission mechanism causes the first peeler to start moving from the first separation position to the first peeling position before the second binding teeth start moving from the pinching position to the retracted position.

### Eleventh Aspect

In the medium processing apparatus according to any one of the first to ninth aspects, the driving force transmission mechanism causes the first peeler to start moving from the first separation position to the first peeling position after the second binding teeth start moving from the pinching position to the retracted position.

### Twelfth Aspect

The medium processing apparatus according to any one of the first to eleventh aspects further includes a slider to slide the crimper in a main scanning direction orthogonal to both a conveyance direction in which the medium is conveyed by the conveyor and the thickness direction.

### Thirteenth Aspect

The medium processing apparatus according to any one of the first to twelfth aspects further includes a staple binder to cause a staple to pass through the plurality of media stacked on the stacker to bind the plurality of media.

### Fourteenth Aspect

The medium processing apparatus according to any one of the first to thirteenth aspects further includes a supply port through which the medium is supplied from an image forming apparatus that forms an image on the medium.

### Fifteenth Aspect

An image forming apparatus includes: an image forming device to form images on a plurality of media; and the medium processing apparatus according to any one of the first to thirteenth aspects to process the plurality of media on which the images are formed by the image forming device.

### Sixteenth Aspect

An image forming system includes: an image forming apparatus to form images on a plurality of media; and the medium processing apparatus according to any one of the first to thirteenth aspects to process the plurality of media on which the images are formed by the image forming apparatus.

Embodiments of the present disclosure are not limited to the above-described embodiments, and numerous additional modifications and variations are possible in light of the teachings within the technical scope of the present disclosure. It is therefore to be understood that the above-described embodiments of the present disclosure may be practiced otherwise by those skilled in the art than as specifically described herein. Such embodiments and variations thereof are included in the scope and gist of the embodiments of the present disclosure and are included in the embodiments described in claims and the equivalent scope thereof. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

This patent application is based on and claims priority to Japanese Patent Application No. 2022-174746, filed on Oct. 31, 2022, in the Japan Patent Office, the entire disclosure of which is hereby incorporated by reference herein.

### REFERENCE NUMERALS

1: Image forming system
2: Image forming apparatus
3: Post-processing apparatus
9: Supply port
10 to 19: Conveyance roller pair
20: Switching plate
21, 30, 36: Output tray
22: Inner tray
23: Tapping roller
24: Return roller
25, 32: End fence
26L, 26R: Side fence
27, 27′, 27A, 27B, 27C: Crimper
28: Staple binder
29: Ejection plate
31: Feeler
33: Binder
34: Sheet folding blade
35: Puncher
37: Guide rail
38: Slide motor
41, 42, 42′: Binding teeth
43, 43′, 43A: Peeling plate
44: Driving motor
45: Driving force transmission mechanism
46, 51, 57, 60: Support shaft
47: Rotation arm
48: Peeling portion
49: Link arm
52: Opening
53: Guide surface
54, 54′: Cam
55: Outer link
56: Inner link
58: Projecting portion
59: Coil spring
61: Protrusion
100: Controller
101: CPU
102: RAM
103: ROM
104: HDD
105: I/F
109: Common bus
110: Operation panel
P: Sheet of Paper
Pb: Sheet bundle
Ph1: First conveyance passage
Ph2: Second conveyance passage
Ph3: Third conveyance passage

1. A medium processing apparatus, comprising:
a conveyor configured to convey a plurality of media;
a stacker configured to stack the plurality of media conveyed by the conveyor; and
a crimper configured to press and deform the plurality of media stacked on the stacker to bind the plurality of media,
the crimper including,
first binding teeth on a first side with respect to the plurality of media stacked on the stacker in a thickness direction of the plurality of media stacked on the stacker;
second binding teeth on a second side with respect to the plurality of media stacked on the stacker in the thickness direction, the second binding teeth configured to move between a pinching position at which the second binding teeth pinch the plurality of media with the first binding teeth, and a retracted position at which the second binding teeth are retracted from the pinching position;
a first peeler configured to move to a first separation position at which the first peeler is separated from the plurality of media stacked on the stacker toward the first binding teeth, and a first peeling position at which the first peeler peels the plurality of media stacked on the stacker from the first binding teeth;
a single driving source configured to provide a driving force; and
a driving force transmission mechanism configured to,
move the second binding teeth between the pinching position and the retracted position using the driving force, and
move the first peeler from the first separation position to the first peeling position in conjunction with the movement of the second binding teeth from the pinching position to the retracted position.

2. The medium processing apparatus according to claim 1, wherein the crimper further includes:
a second peeler configured to move to a second separation position at which the crimper is separated from the plurality of media stacked on the stacker toward the second binding teeth, and a second peeling position at which the crimper peels the plurality of media stacked on the stacker from the second binding teeth.

3. The medium processing apparatus according to claim 2, wherein the driving force transmission mechanism is further configured to:
move the second peeler from the second separation position to the second peeling position in conjunction with the movement of the second binding teeth from the pinching position to the retracted position using the driving force.

4. The medium processing apparatus according to claim 3, wherein the driving force transmission mechanism is further configured to:
cause the second peeler to start moving from the second separation position to the second peeling position before causing the first peeler to start moving from the first separation position to the first peeling position.

5. The medium processing apparatus according to claim 3, further comprising:
a rotation arm configured to be rotated by the driving force, wherein
the second binding teeth are configured to be attached to the rotation arm such that the second binding teeth rotate between the pinching position and the retracted position,
the rotation arm includes a protrusion configured to contact and separate from the second peeler,
the second peeler is further configured to,
separate from the protrusion while the second binding teeth move from the retracted position to the pinching position, and
rotate from the second separation position to the second peeling position by the rotation of the rotation arm, and
the second peeler is further configured to contacts the protrusion in a process including the second binding teeth moving from the pinching position to the retracted position, and the second peeler being held at the second peeling position.

6. The medium processing apparatus according to claim 1, wherein the driving force transmission mechanism includes:
a cam including a projecting portion at a part of the cam in a circumferential direction of the cam, the cam configured to be rotated by the driving force; and
a link configured to move the second binding teeth between the pinching position and the retracted position in conjunction with the rotation of the cam, and
the first peeler is further configured to move from the first separation position to the first peeling position by being pressed by the projecting portion of the cam in a process in which the second binding teeth moves from the pinching position to the retracted position.

7. The medium processing apparatus according to claim 1, wherein the crimper further includes:
a biasing member configured to bias the first peeler toward the first separation position.

8. The medium processing apparatus according to claim 1, wherein the first peeler further includes:
a guide face configured to guide the plurality of media between the first binding teeth and the second binding teeth, and
the guide face is at an upstream end of the first peeler in a conveyance direction in which the plurality of media are conveyed by the conveyor.

9. The medium processing apparatus according to claim 1, wherein
the first peeler has a plate shape having an opening through which the first binding teeth are configured to protrude and retract;
in response to the first peeler being located at the first separation position, the first binding teeth are further configured to protrude through the opening toward the plurality of media stacked on the stacker; and
in response to the first peeler being located at the first peeling position, the first binding teeth are further configured to retract through the opening to a side opposite to the plurality of media stacked on the stacker.

10. The medium processing apparatus according to claim 1, wherein the driving force transmission mechanism is further configured to:
cause the first peeler to start moving from the first separation position to the first peeling position before the second binding teeth start moving from the pinching position to the retracted position.

11. The medium processing apparatus according to claim 1, wherein the driving force transmission mechanism is further configured to:
cause the first peeler to start moving from the first separation position to the first peeling position after the second binding teeth start moving from the pinching position to the retracted position.

12. The medium processing apparatus according to claim 1, further comprising:
a slider configured to slide the crimper in a main scanning direction orthogonal to both a conveyance direction in which the plurality of media are conveyed by the conveyor and the thickness direction.

13. The medium processing apparatus according to claim 1, further comprising:
a staple binder configured to cause a staple to pass through the plurality of media stacked on the stacker to bind the plurality of media.

14. The medium processing apparatus according to claim 1, further comprising:
a supply port through which the plurality of media are supplied from an image forming apparatus, the image forming apparatus configured to form at least one image on at least one medium of the plurality of media.

15. An image forming apparatus comprising:
an image forming device to form images on a plurality of media; and
the medium processing apparatus according to claim 1, the medium processing apparatus configured to process the plurality of media on which the images are formed by the image forming device.

16. An image forming system, comprising:
an image forming apparatus configured to form images on a plurality of media; and
the medium processing apparatus according to claim 1, the medium processing apparatus configured to process the plurality of media on which the image is formed by the image forming apparatus.
